(19) United States
(12) Patent Application Publication
(10) Pub. No.: US 2012/0262358 A1
(43) Pub. Date: Oct. 18, 2012

(54) BEAM FORMING ANTENNA

(76) Inventor: GEORGE WALLNER, MIAMI BEACH, FL (US)

(21) Appl. No.: 13/443,977

(22) Filed: Apr. 11, 2012

Related U.S. Application Data
(60) Provisional application No. 61/474,787, filed on Apr. 13, 2011.

(51) Int. Cl. H01Q 19/10

(52) U.S. Cl. 343/833; 343/837

(57) ABSTRACT

A high frequency (HF) beam antenna includes a set of radiating vertical monopole elements and a set of horizontal dipole elements. The horizontal dipole elements are parasitically coupled to corresponding radiating vertical monopole elements and are configured to counterpoise radiation from the radiating vertical monopole elements and to effectively isolate the vertical monopole elements from the underlying ground. The HF beam antenna has a high performance gain and low angles of radiation when installed at a height of 0.1 to 0.2 wavelength above ground. The HF beam antenna eliminates the need for a tower in the HF service range.

### CROSS REFERENCE TO RELATED CO-PENDING APPLICATIONS

This application claims the benefit of U.S. provisional application Ser. No. 61/474,787 filed on Apr. 13, 2011 and entitled BEAM FORMING ANTENNA which is commonly assigned and the contents of which are expressly incorporated herein by reference.

### FIELD OF THE INVENTION

The present invention relates to a high frequency (HF) beam forming antenna that satisfies the need for a high performance gain antenna.

### BACKGROUND OF THE INVENTION

Beam forming high frequency (HF) (2 to 30 MHz) antennas, such as Yagi and Log-Periodic antennas, are usually horizontally polarized. When mounted low above the ground, horizontally polarized antennas have high radiation angles resulting in poor long distance performance.

Long distance communications at HF frequencies rely on the ionosphere refracting signals back to earth. These refractions occur at heights of 200 to 300 kilometers. To reach long distances (2000 to 4000 km), signals must be launched at low angles so they reach the ionosphere as far from the transmitter as possible and thus, after refraction, return to earth the farthest possible. Signals launched at high angles return to earth much closer and often need multiple reflections and refractions (so called hops) to reach the distant receiver. Multiple hops result in significant signal loss and thus poor reception. Therefore, low angle radiation is a very desirable characteristic of long distance (DX) HF antennas. Radiation angles of 20 degrees or less are considered to be good for these purposes.

Radiation from horizontally polarized antennas (where the electrical field is parallel to the ground) is out of phase with radiation reflected from the ground. This results in the two radiations cancelling each other at low angles. This can be overcome by raising the antenna above the ground, effectively shifting its phase to reduce signal cancellation at low angles. Ideally, a horizontally polarized antenna, such as a Yagi antenna, should be raised to a height of one wavelength above ground to achieve optimum low angle radiation. Compromise heights of 0.5 to one wavelength result in compromised performance and significant ground losses. At lower heights the horizontally polarized antenna is almost useless for long distance communications.

To obtain the necessary heights, horizontally polarized HF beam antennas are installed on towers or other high structures. This requirement severely restricts their use in residential areas where either local ordinances or community covenants restrict the height and visibility of structures. For example, to be an effective long distance antenna, a Yagi beam antenna designed to operate in the 14 MHz radio amateur band, should be installed at a height of at least 15 meters (45 feet). In practice, tower heights range between 45 and 120 feet. A large number of amateur radio operators, who live in neighborhoods with antenna restrictions, are not able install towers and therefore are seriously disadvantaged. They are limited to low dipole or ground mounted vertically polarized antennas that have either no, or limited beam forming capabilities, and suffer from ground losses.

Although, most existing beam forming antennas in the HF service are horizontally polarized (such as Yagi and Log-Periodic antennas), there are also some vertically polarized beam forming antennas that may be used in the HF frequency range. Vertically polarized beam forming antennas are usually phased vertical arrays that require extensive radial fields, and therefore they often suffer from high ground losses. Their performance is strongly dependent on ground quality, and can be very poor when mounted over low conductivity ground.

Beam forming antennas are desirable as they concentrate the radiated radio energy in the direction of the receiver. They can easily achieve gains of 10 dB, which provides a ten fold signal increase at the receiving end. Accordingly, it is desirable to have a high gain HF antenna beam forming antenna that does not have the above mentioned angle, height and ground requirements of the prior art HF antennas.

### SUMMARY OF THE INVENTION

This invention describes a beam forming HF antenna that satisfies the need for a high performance gain antenna that provides low angles of radiation when installed at 0.1 to 0.2 wavelength above ground. The antenna eliminates the need for a tower in the HF service.

In general, one aspect of the invention provides a high frequency (HF) beam antenna including a set of radiating vertical monopole elements and a set of horizontal dipole elements. The horizontal dipole elements are parasitically coupled to corresponding radiating vertical monopole elements and are configured to counterpoise radiation from the radiating vertical monopole elements and to effectively isolate the vertical monopole elements from the underlying ground.

Implementations of this aspect of the invention include the following. The set of radiating vertical monopole elements includes at least three vertical monopole elements arranged inline and parallel to each other. The three monopole elements include a fed element, a reflector element and a director element. The fed element is connected to a signal feed line and is configured to emit radiated energy and the reflector and director elements are parasitically coupled to the fed element. The reflector and director elements are sized and spaced apart from the fed element so that they cause phase shifts in the radiated energy and the phase shifts cause the radiated energy to add constructively in a forward direction and to cancel in a rearward direction, thereby forming a radiated energy beam. The antenna further includes a horizontally extending boom and the set of radiating vertical monopole elements are mounted perpendicularly onto the boom and the set of horizontal dipole elements are mounted coplanar and perpendicular to the boom. The antenna further includes a vertical mast and the vertical mast is secured in the underlying ground and the boom is mounted on top of the vertical mast. The mast has a height of less than 5 meters above ground. The mast has a height in the range of 0.1 to 0.2 wavelength above ground. The antenna further includes a rotating mechanism for rotating the set of radiating vertical monopole elements and the set of horizontal dipole elements. The antenna may further include a plurality of sets of radiating vertical monopole elements configured to emit radiation in multiple ranges of frequencies and a plurality of sets of horizontal dipole elements. The sets of horizontal dipole elements are parasitically coupled to the sets of radiating vertical monopole elements and are configured to counterpoise radiation from the sets of radiating vertical monopole elements and to effectively isolate the sets of vertical monopole elements from the underlying ground. Each horizontal dipole element includes first and second components and the first and second components are arranged and dimensioned so that they provide current return paths for the corresponding vertical element.

In general in another aspect the invention provides a method for generating a high frequency (HF) beam including providing a set of radiating vertical monopole elements, providing a set of horizontal dipole elements and coupling the horizontal dipole elements parasitically to corresponding radiating vertical monopole elements so that radiation from the radiating vertical monopole elements is counterpoise by the horizontal dipole elements and the vertical monopole elements are effectively isolated from the underlying ground.

Among the advantages of this invention may be one or more of the following. The rotatable vertically polarized beam forming antenna achieves low radiation angles from moderate heights (0.1 to 0.2 wavelength above ground) and does not suffer from excessive ground losses. Because this antenna does not require a tower, it can be installed in neighborhoods with restrictions on tall structures.

### BRIEF DESCRIPTION OF THE DRAWINGS

Referring to the figures, wherein like numerals represent like parts throughout the several views:

FIG. 1 depicts an array of phased vertical antennas;

FIG. 2 depicts a Yagi antenna on a tower; and

FIG. 3 depicts a HF beam antenna according to this invention.

### DETAILED DESCRIPTION OF THE INVENTION

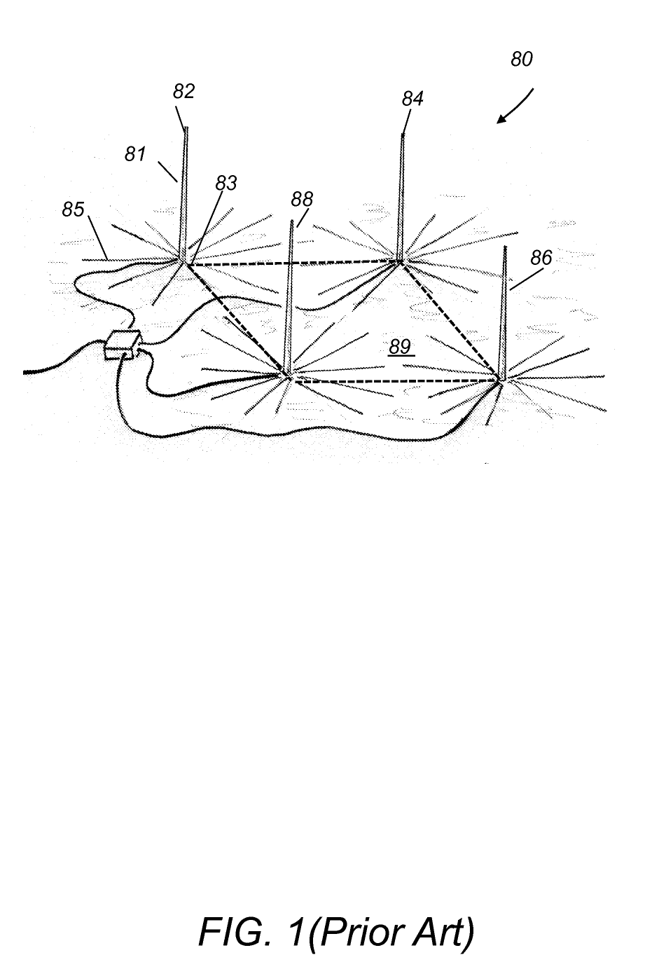

Beam forming antennas in the HF service are either vertically or horizontally polarized. Referring to FIG. 1, a vertically polarized phased array of vertical antennas 80, called Four Square, includes four vertical antennas 82, 84, 86 and 88 that are arranged in the corners of a square 89. Each vertical antenna has a vertical mast 81 and a plurality of horizontal wires (radials) 85 extending radially from its base 83. The number and length of radials 85 strongly affect performance. Radials 85 are either buried or laying on the ground. Low ground conductivity (common in suburban environments) must be compensated for by adding more and longer radials. Because of these requirements, vertical arrays are seldom used by space limited stations.

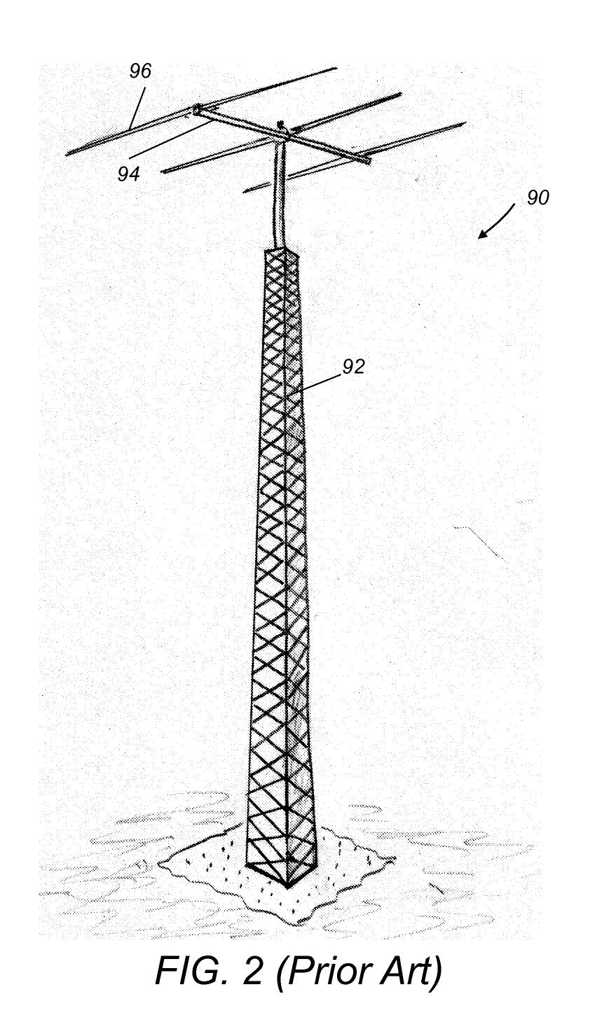

Referring to FIG. 2, horizontally polarized beam forming antennas 90, such as Yagi and Log-Periodic antennas, must be mounted one wave-length above the ground to achieve low angles (20 degrees or less) of radiation and to avoid significant ground losses. The Yagi antenna is a parasitic array of dipole elements 96, one of which is a fed element 94 to which the other elements couple parasitically.

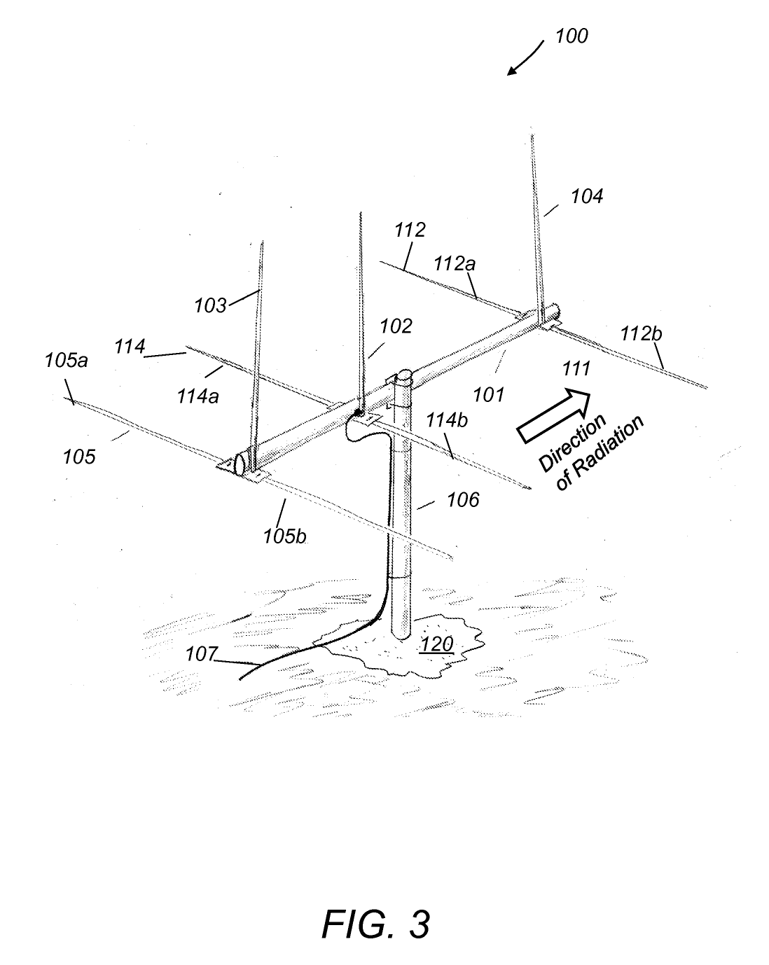

The antenna of this invention is a ground independent vertically polarized multi-element parasitic array that has low angles of radiation even when mounted at moderate heights, i.e., 3 to 4 meters. Referring to FIG. 3, antenna 100 includes a set of monopole vertical elements 103, 102, 104 and a set of horizontal dipole elements 105, 114, 112. One of the vertical elements 102 (fed element) is connected to the feed line 107. The other two vertical elements 103, 104 couple parasitically to the fed element 102. Vertical parasitic element 103 is a reflector and vertical parasitic element 104 is a director. The parasitic elements 103, 104 are spaced and sized similarly to the elements of a Yagi antenna to create the required phase-shift necessary for beam forming.

Unlike on a Yagi antenna, the present antenna's horizontal elements 105, 112, 114 do not radiate. Only the vertical elements 102, 103, 104 radiate, which generates a vertically polarized signal. The horizontal elements 105, 112, 114 act as counterpoise to the vertical elements 102, 103, 104 and effectively isolate the radiating elements from the underlying ground, thereby avoiding the ground losses that affect horizontally polarized antennas or vertical antennas over ground. All elements 102, 103, 104, 105, 112, 114 are supported onto a horizontal boom 101. Boom 101 is mounted on the top of a vertical mast 106, which is secured in the ground 120.

The boom 101 provides mechanical support for the entire antenna structure. When made out of metal, the boom also provides grounding for all the elements. This ground plays a negligible role in the RF performance of the antenna, but is generally provided for lightning protection.

The fed element 102 is the active element that is fed the radio frequency (RF) energy from the feed line 107 (coaxial cable). The fed element 102, which is vertically polarized, and may also contain an impedance matching structure, is parasitically coupled to the two vertical parasitic elements 103 and 104.

The rear parasitic element 103 (reflector) is sized to be longer than the fed element 102. The forward parasitic element 104 (director), is sized to be shorter. There may be more than one director in an array. The size differences between the fed element 102, the reflector 103 and the director 104 result in phase-shifts that cause the radiated energy to add constructively in the forward direction, and cancel in the rearward direction. Thus the antenna forms a beam of radiation in the forward direction 111. The antenna thus has a gain in the forward direction 111 at the expense of the side and rear directions. When the antenna is pointed in the desired direction of communications this gain results in increased signal strength at the other end of the link. Likewise, the received signal also experiences gain, while the noise received from the other directions is attenuated.

Each of the horizontal elements 105, 112, 114 includes a set of two horizontal elements 105a, 105b, 112a, 112b, and 114a, 114b, respectively. Each set of the two horizontal elements (i.e., 105a, 105b) provides a current return path for the corresponding vertical element (i.e., 103), and enables the vertical element to resonate at the appropriate frequencies. Because of the opposing phases of currents in the horizontal elements 105a, 105b, these elements do not radiate, although they play an important role in the beam-forming function of the antenna. The horizontal elements are sized the same as their corresponding vertical counterparts. Importantly, they “shield’ the antenna from the lossy ground. The feed cable 107, usually a coaxial cable, carries RF power from the transmitter to the antenna.

The antenna is installed on a short (3 to 4 meter) mast 106, that is between 0.1 to 0.2 wavelength above ground and may be equipped with a rotating mechanism. The antenna may be made to work on multiple ranges of frequencies by adding additional sets of elements sized for those frequencies (interlaced or forward staggered).

Several embodiments of the present invention have been described. Nevertheless, it will be understood that various modifications may be made without departing from the spirit and scope of the invention. Accordingly, other embodiments are within the scope of the following claims.

What is claimed is:

1. A high frequency (HF) beam antenna comprising:
a set of radiating vertical monopole elements;
a set of horizontal dipole elements;
wherein said horizontal dipole elements are parasitically coupled to corresponding radiating vertical monopole elements and are configured to counterpoise radiation from the radiating vertical monopole elements and to effectively isolate the vertical monopole elements from the underlying ground.

2. The antenna of claim 1 wherein said set of radiating vertical monopole elements comprises at least three vertical monopole elements arranged inline and parallel to each other and wherein said three monopole elements comprise a fed element, a reflector element and a director element and wherein said fed element is connected to a signal feed line and is configured to emit radiated energy and said reflector and director elements are parasitically coupled to the fed element.

3. The antenna of claim 2 wherein the reflector and director elements are sized and spaced apart from the fed element so that they cause phase shifts in the radiated energy and wherein the phase shifts cause the radiated energy to add constructively in a forward direction and to cancel in a rearward direction, thereby forming a radiated energy beam.

4. The antenna of claim 1 further comprising a horizontally extending boom and wherein said set of radiating vertical monopole elements are mounted perpendicularly onto said boom and said set of horizontal dipole elements are mounted coplanar and perpendicular to said boom.

5. The antenna of claim 4 further comprising a vertical mast and wherein the vertical mast is secured in the underlying ground and the boom is mounted on top of the vertical mast.

6. The antenna of claim 5, wherein said mast comprises a height of less than 5 meters above ground.

7. The antenna of claim 5, wherein said mast comprises a height in the range of 0.1 to 0.2 wavelength above ground.

8. The antenna of claim 1, further comprising a rotating mechanism for rotating said set of radiating vertical monopole elements and said set of horizontal dipole elements.

9. The antenna of claim 1, further comprising a plurality of sets of radiating vertical monopole elements configured to emit radiation in multiple ranges of frequencies and a plurality of sets of horizontal dipole elements and wherein the sets of horizontal dipole elements are parasitically coupled to the sets of radiating vertical monopole elements and are configured to counterpoise radiation from the sets of radiating vertical monopole elements and to effectively isolate the sets of vertical monopole elements from the underlying ground.

10. The antenna of claim 1 wherein each horizontal dipole element comprises first and second components and wherein said first and second components are arranged and dimensioned so that they provide current return paths for the corresponding vertical element.

11. A method for generating a high frequency (HF) beam comprising:
providing a set of radiating vertical monopole elements;
providing a set of horizontal dipole elements;
coupling said horizontal dipole elements parasitically to corresponding radiating vertical monopole elements so that radiation from the radiating vertical monopole elements is counterpoise by the horizontal dipole elements and the vertical monopole elements are effectively isolated from the underlying ground.

12. The method of claim 11, wherein said set of radiating vertical monopole elements comprises at least three vertical monopole elements arranged inline and parallel to each other and wherein said three monopole elements comprise a fed element, a reflector element and a director element and wherein said fed element is connected to a signal feed line and is configured to emit radiated energy and said reflector and director elements are parasitically coupled to the fed element.

13. The method of claim 12 wherein the reflector and director elements are sized and spaced apart from the fed element so that they cause phase shifts in the radiated energy and wherein the phase shifts cause the radiated energy to add constructively in a forward direction and to cancel in a rearward direction, thereby forming a radiated energy beam.

14. The method of claim 11 further comprising providing a horizontally extending boom and mounting said set of radiating vertical monopole elements perpendicularly onto said boom and mounting said set of horizontal dipole elements coplanar and perpendicular to said boom.

15. The method of claim 14 further comprising providing a vertical mast and wherein the vertical mast is secured in the ground and the boom is mounted on top of the vertical mast.

16. The method of claim 15, wherein said mast comprises a height of less than 5 meters above ground.

17. The method of claim 15, wherein said mast comprises a height in the range of 0.1 to 0.2 wavelength above ground.

18. The method of claim 11, further comprising rotating said a set of radiating vertical monopole elements and said a set of horizontal dipole elements.

19. The method of claim 11, further comprising providing a plurality of sets of radiating vertical monopole elements configured to emit radiation in multiple ranges of frequencies and a plurality of sets of horizontal dipole elements and coupling the sets of horizontal dipole elements parasitically to the sets of radiating vertical monopole elements so that radiation from the sets of radiating vertical monopole elements is counterpoised and the sets of vertical monopole elements are effectively isolated from the underlying ground.

20. The method of claim 11, wherein each horizontal dipole element comprises first and second components and wherein said first and second components are arranged and dimensioned so that they provide current return paths for the corresponding vertical element.
